(19) United States
(12) Patent Application Publication
(10) Pub. No.: US 2004/0123852 A1
(43) Pub. Date: Jul. 1, 2004

(54) Ignition coil assembly for engine

(76) Inventors: Koji Tsunenaga, Chiryu-city (JP); Yoshihiro Shimoide, Chita-gun (JP)

Correspondence Address: NIXON & VANDERHYE, PC, 1100 N GLEBE ROAD, 8TH FLOOR, ARLINGTON, VA, 22201-4714, US

(21) Appl. No.: 10/456,470

(22) Filed: Jun. 9, 2003

(30) Foreign Application Priority Data
Jun. 12, 2002 (JP) 2002-171254

(51) Int. Cl. F02P 3/02

(52) U.S. Cl. 123/635

(57) ABSTRACT

In an ignition coil assembly, a plurality of ignition coils is arranged to be electrically connected to spark plugs received in plug holes of an engine. A base cover includes a plurality of receiving through holes, which are arranged at corresponding positions that correspond to positions of the plug holes, respectively. A top cover covers a top surface of the base cover and secures each ignition coil through engagement with the head of each ignition coil. Fastening bolts temporarily fasten the top cover and the base cover in a manner that allows sliding adjustment of a securing position of each ignition coil, which is loosely received in a corresponding one of the base cover through holes, in an imaginary plane that is perpendicular to an axis of each ignition coil.

### CROSS REFERENCE TO RELATED APPLICATION

This application is based on and incorporates herein by reference Japanese Patent Application No. 2002-171254 filed on Jun. 12, 2002.

### BACKGROUND OF THE INVENTION

1. Field of the Invention

The present invention generally relates to an ignition coil device for an engine of, for example, an automobile and more specifically to an ignition coil assembly that includes a plurality of ignition coils, which are connected to corresponding spark plugs securely installed in plug holes of the engine.

2. Description of Related Art

For example, Japanese Unexamined Patent Publication No. 9-250437 discloses an integrated connector block, in which connectors for supplying electricity to corresponding ignition coils are integrated. The integrated connector block includes a connector block main body, which is formed as an elongated body made of a resin material. Coil connectors are integrally formed in a lower surface of the connector block main body. Each ignition coil, which is secured to a corresponding spark plug installed in an engine, is installed to and is thus engaged with a corresponding one of the coil connectors in an axial direction of the corresponding ignition coil, i.e., in an axial direction of the corresponding spark plug.

Furthermore, in order to allow installation of the ignition coils to the plug holes of the engine in a single step, an ignition coil assembly, which includes a plurality of ignition coils arranged at predetermined intervals, has been proposed. For example, as shown in FIG. 8, one such ignition coil assembly 51 includes a resin base member 53 that holds a plurality of ignition coils 52 at corresponding positions, which correspond to positions of plug holes 131 of an engine 130. Each ignition coil 52 may be threadably secured to the base member 53 through use of a bolt. Alternatively, each ignition coil 52 and the base member 53 may be integrally molded using a resin material. In either way, each ignition coil 52 and the base member 53 are integrated together. Thereafter, the ignition coil assembly 51 is installed to the engine 130 by axially installing the ignition coils 52 into the corresponding plug holes 131, and longitudinal ends and the center of the base member 53 are secured to the engine 130 by bolts 53c. The bolts 53c are received through corresponding through holes 53a of the base member 53 and are threadably engaged with screw holes 132 of the engine 130.

However, in the previously proposed ignition coil assembly 51, manufacturing errors in the intervals (plug hole pitches) of the plug holes 131 of the engine 130 and manufacturing errors in the intervals (securing point pitches) of the ignition coils 52 need to be minimized, resulting in a difficulty in manufacturing of the ignition coil assembly. That is, when there is a substantial deviation between the plug hole pitches of the plug holes 131 and the securing point pitches of the ignition coils 52, it could happen that each ignition coil 52 secured to the base member 53 cannot be linearly inserted into the corresponding plug hole 131.

### SUMMARY OF THE INVENTION

The present invention addresses the above disadvantage. Thus, it is an objective of the present invention to provide an ignition coil assembly that allows sliding adjustment of a securing position of each ignition coil in an imaginary plane that is perpendicular to an axis of the ignition coil.

To achieve the objective of the present invention, there is provided an ignition coil assembly for an engine. The engine includes a plurality of plug holes, each of which receives a corresponding one of a plurality of spark plugs. The ignition coil assembly includes a plurality of ignition coils, a base cover, a top cover and a temporarily fastening member. The ignition coils are arranged to be electrically connected to the spark plugs, respectively. Each ignition coil includes a head and a main body, which extends from the head. The base cover includes a plurality of receiving through holes, which penetrate through the base cover and are arranged at corresponding positions that correspond to positions of the plug holes, respectively. The main body of each ignition coil is received through a corresponding one of the receiving through holes such that a gap is defined between the main body of each ignition coil and an inner peripheral wall of the corresponding one of the receiving through holes. The head of each ignition coil is supported by the base cover around a peripheral edge of the corresponding one of the receiving through holes. The top cover covers a top surface of the base cover and secures each ignition coil through engagement with the head of each ignition coil. The temporarily fastening member temporarily fastens the top cover and the base cover in a manner that allows sliding adjustment of a securing position of each ignition coil in an imaginary plane that is perpendicular to an axis of each ignition coil.

### BRIEF DESCRIPTION OF THE DRAWINGS

The invention, together with additional objectives, features and advantages thereof, will be best understood from the following description, the appended claims and the accompanying drawings in which:

FIG. 1 is a schematic side view of an ignition coil assembly according to a first embodiment of the present invention, showing a state where a top cover and a base cover of the ignition coil assembly are temporarily fastened;

FIG. 2 is a schematic side view showing a state after installation of the ignition coil assembly of the first embodiment into an engine;

FIG. 3A is an enlarged schematic view showing an ignition coil positioned in the center of a corresponding receiving through hole of the base cover;

FIG. 3B is an enlarged schematic view showing the ignition coil positioned in the left side in the receiving through hole of the base cover;

FIG. 3C is an enlarged schematic view showing the ignition coil positioned in the right side in the receiving through hole of the base cover;

FIG. 4 is an enlarged schematic view showing a structure for temporarily fastening the top cover and the base cover;

FIG. 5 is an enlarged schematic view showing a structure for temporarily fastening a top cover and a base cover of an ignition coil assembly according to a second embodiment of the present invention;

FIG. 6 is an enlarged schematic view showing a structure around a coil stop protrusion of an ignition coil assembly according to a third embodiment of the present invention;

FIG. 7A is an enlarged view showing a structure around a coil stop protrusion of an ignition coil assembly according to a fourth embodiment of the present invention;

FIG. 7B is a plan view showing a head of a coil of the ignition coil assembly according to the fourth embodiment; and

FIG. 8 is a schematic perspective view showing a previously proposed ignition coil assembly.

### DETAILED DESCRIPTION OF THE INVENTION

Various embodiments of the present invention will be described with reference to the accompanying drawings.

(First Embodiment)

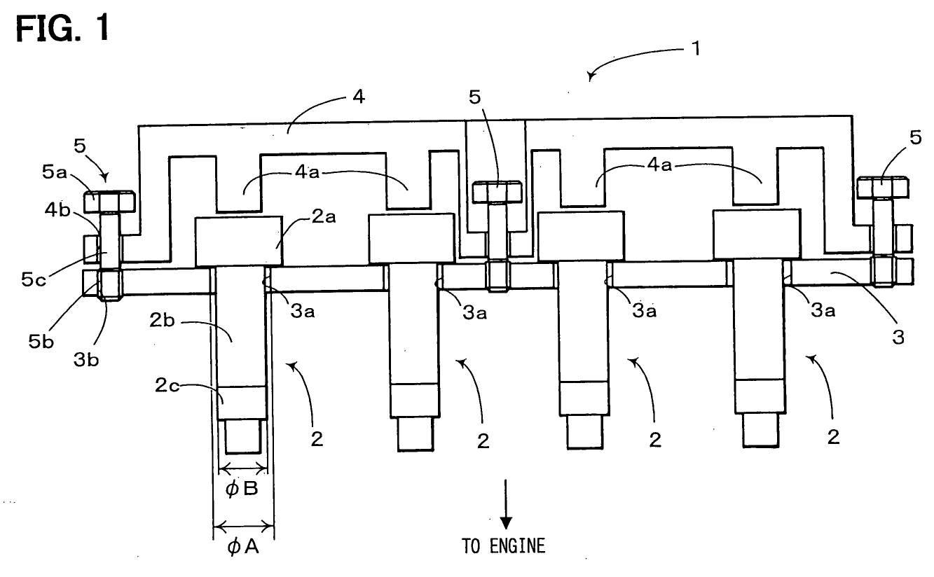

An ignition coil assembly 1 according to a first embodiment of the present invention will be described with reference to FIGS. 1 to 4.

The ignition coil assembly 1 is for an automobile engine and includes a plurality of ignition coils 2, which are arranged at predetermined intervals and are axially connected to corresponding spark plugs securely received in plug holes of the engine.

That is, as shown in FIGS. 1 to 4, the ignition coil assembly 1 includes the ignition coils 2, a base cover 3, a top cover 4 and three fastening bolts 5. The base cover 3 supports the ignition coils 2 at predetermined intervals. The top cover 4 is arranged to cover a top surface of the base cover 3. The fastening bolts 5 serve as fastening screws that secure both the base cover 3 and the top cover 4 to the engine 30. It should be understood that the ignition coil assembly 1 shown in FIG. 1 is for a four cylinder engine and thus includes four ignition coils 2.

Each ignition coil 2 is formed as a stick shaped component that has a case, which is made of a dielectric resin material and receives an electric circuit for generating high voltage to be supplied to the corresponding spark plug 32. As shown in FIG. 1, each ignition coil 2 includes a head 2a, a cylindrical main body 2b and a tubular plug cap 2c. The head 2a is arranged at the top end of the ignition coil 2. The cylindrical main body 2b extends downwardly from the head 2a. The tubular plug cap 2c is connected to the lower end of the main body 2b.

The head 2a is formed as a generally cubic body. A size of the head 2a, i.e., a diameter of the circumcircle, which passes through all vertices of the head 2a in a plane that is perpendicular to the axis of the ignition coil 2, is greater than the inner diameter of a corresponding one of the plug holes 31 of the engine 30. A connector (not shown) projects laterally from one side of the head 2a of each ignition coil 2. The connector of each ignition coil 2 is connected to a connector of a cord electrically connected to a battery (not shown) to allow supply of electric current to the ignition coil 2. The connectors are not shown in FIG. 1 since each connector is located on a back side of the head 2a of the corresponding ignition coil 2.

The cylindrical main body 2b has the outer diameter smaller than the size of the head 2a and is inserted into the corresponding plug hole 31. Thus, each ignition coil 2 is installed to the base cover 3 such that the main body 2b of the ignition coil 2 is inserted through a corresponding one of receiving through holes 3a of the base cover 3, and the head 2a is placed over the top surface of the base cover 3 around the corresponding one of the receiving through holes 3a.

The tubular plug cap 2c is formed as a tubular body made of a resilient material, such as a rubber material. When the ignition coil 2 is inserted into the corresponding plug hole 31, an inner peripheral surface of the plug cap 2c of the ignition coil 2 receives a top end of the corresponding spark plug 32 such that the ignition coil 2 and the spark plug 32 are connected to each other. Each of the plug cap 2c and the main body 2b has a corresponding internal engaging structure that allows secure engagement between the plug cap 2c and the main body 2b at the inside thereof. The plug cap 2c and the main body 2b are securely engaged with each other in a manner that prevents disengagement of the plug cap 2c from the main body 2b even when the plug cap 2c is axially pulled in a direction away from the main body 2b.

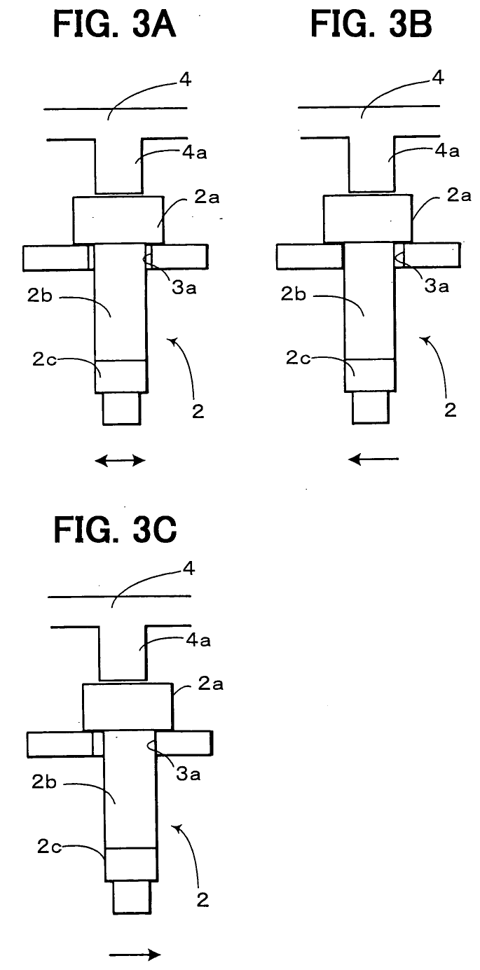

The base cover 3 is an elongated plate like body made of, for example, a dielectric resin material. The receiving through holes 3a of the base cover 3 are arranged at corresponding positions that correspond to positions of the plug holes 31 of the engine 30 and receive the main body 2b of the corresponding ignition coil 2. The inner diameter φA of each receiving through hole 3a is greater than the outer diameter φB of the corresponding main body 2b such that the main body 2b is loosely received through the receiving through hole 3a. Thus, when the main body 2b is received through the receiving through hole 3a, there is provided play (or a gap), which corresponds to φA-φB, between the main body 2b and an inner peripheral wall of the corresponding through hole 3a. As a result, each ignition coil 2 can slide within the range of φA-φB in an imaginary plane that is perpendicular to the axis of the ignition coil 2. To illustrate the slidably received ignition coil 2, FIG. 3A shows the ignition coil 2 positioned in the center of the receiving through hole 3a. Also, FIG. 3B shows the ignition coil 2 positioned in the left side in the receiving through hole 3a. Furthermore, FIG. 3C shows the ignition coil 2 positioned in the right side in the receiving through hole 3a. It is desirable that the amount ofφA-φB is kept within the tolerance of the corresponding plug hole pitch.

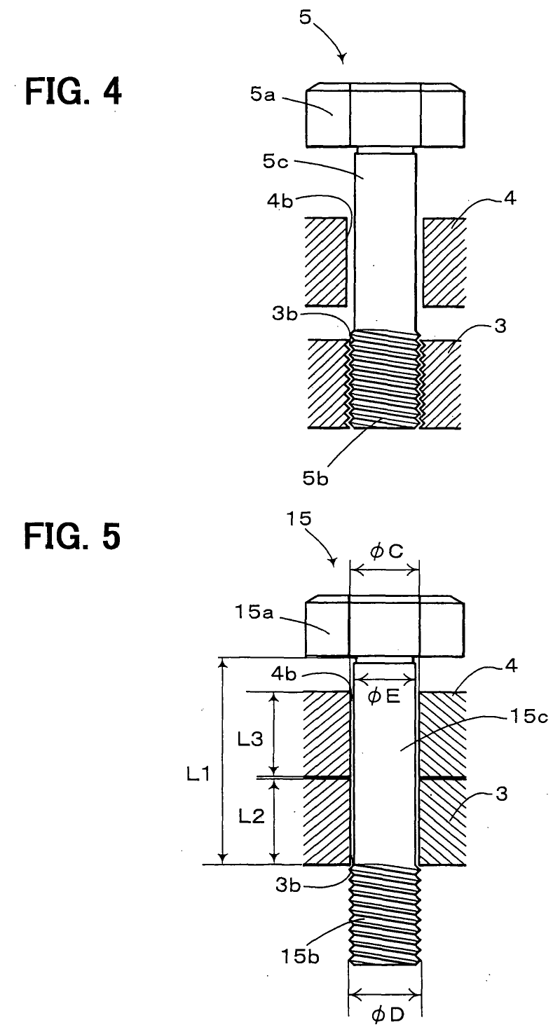

Three base cover through holes 3b are provided in the base cover 3. Two of the base cover through holes 3b are positioned in the opposed longitudinal ends of the base cover 3, and the last one of the base cover through holes 3b is positioned in the center of the base cover 3. Female threads, which are threadably engageable with male threads of a male threaded portion 5b of the corresponding fastening bolt 5, are formed along an inner peripheral surface of each base cover through hole 3b (see FIG. 4).

Similar to the base cover 3, the top cover 4 is an elongated plate like body made of, for example, a dielectric resin material. A plurality of coil stop protrusions 4a is provided in a lower surface of the top cover 4 to protrude downward. The positions of the coil stop protrusions 4a correspond to the positions of the ignition coils 2.

Three top cover through holes 4b are provided in the top cover 4. Two of the top cover through holes 4b are positioned in the opposed longitudinal ends of the top cover 4, and the last one of the top cover through holes 4b is positioned in the center of the top cover 4. The top cover through holes 4b are arranged coaxially with the corresponding base cover through holes 3b.

Each fastening bolt 5 is formed as a hexagonal bolt and includes the head 5a, the male threaded portion 5b and an underhead portion 5c. The head 5a is provided at a proximal end of the bolt 5. The male threaded portion 5b is provided at a distal end of the bolt 5 and is provided with the male threads, which are threadably engageable with the female threads of the corresponding base cover through hole 3b. The underhead portion 5c is provided between the head 5a and the male threaded portion 5b and has an unthreaded smooth outer surface. The axial length of the underhead portion 5c is set to be longer than the axial length of the top cover through hole 4b (in other words, the thickness of the top cover 4) to allow slide movement of the top cover 4 in the axial direction (i.e., the vertical direction in FIG. 1) of the fastening bolt 5 when each male threaded portion 5b is threadably engaged with the female threads of the corresponding base cover through hole 3b.

The top cover 4 is installed such that the top cover 4 covers a top surface of the base cover 3. Furthermore, each fastening bolt 5 is received through both the corresponding top cover through hole 4b and the corresponding base cover through hole 3b, and the male threaded portion 5b of the fastening bolt 5 is threadably engaged with the female threads of the corresponding base cover through hole 3b. In this way, the top cover 4 and the base cover 3 are temporarily fastened together.

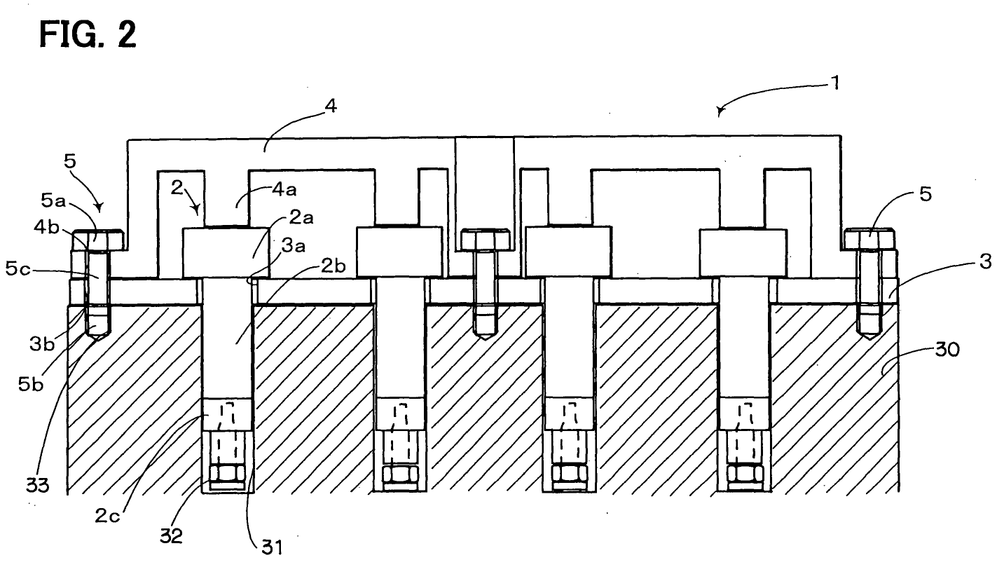

Installation procedure of the ignition coil assembly 1 into the engine 30 will be described with reference to FIGS. 1 and 2.

First, as shown in FIG. 1, after the top cover 4 and the base cover 3 are temporarily fastened together by the fastening bolts 5, the ignition coil assembly 1 is placed over the engine 30 such that the ignition coils 2 are aligned with the plug holes 31, respectively, of the engine 30.

Then, the ignition coil assembly 1 is lowered such that each ignition coil 2 is axially inserted into the corresponding plug hole 31, and the base cover 3 is placed on the top surface of the engine 30. Furthermore, the top surface of the top cover 4 is urged downward, so that the inner peripheral surface of the plug cap 2c of each ignition coil 2 is engaged with the top end of the corresponding spark plug 32. In this way, the ignition coil 2 and the spark plug 32 are connected to each other. Even if substantial manufacturing error in the hole pitches of the plug holes 31 occurs, each ignition coil 2 can be easily and reliably secured in the corresponding plug hole 31 in the following manner. That is, as described above, the main body 2b of each ignition coil 2 is loosely received in the corresponding receiving through hole 3a of the base cover 3, and the top cover 4 and the base cover 3 are temporarily fastened by the fastening bolts 5, so that each ignition coil 2 can be inserted into the corresponding plug hole 31 and can abut against the inner peripheral surface of the corresponding plug hole 31 to achieve sliding adjustment of the position of each ignition coil 2 in the imaginary plane that is perpendicular to the axis of the ignition coil 2. Each coil stop protrusion 4a located in the lower surface of the top cover 4 is downwardly pressed against the head 2a of the corresponding ignition coil 2 to secure the same.

Thereafter, each fastening bolt 5, which is inserted into the corresponding top cover through hole 4b and the corresponding base cover through hole 3b, is rotated clockwise (i.e., rotated in the tightening direction), so that the male threaded portion 5b of each fastening bolt 5 is threaded into the corresponding screw hole 33 of the engine 30, and thereby the top cover 4 and the base cover 3 are integrally secured to the engine 30.

Finally, the connector (not shown) of each ignition coil 2 located at the back side of the head 2a is connected to the corresponding connector of the cord connected to the battery (not shown). In this way, installation of the ignition coil assembly 1 into the engine 30 is completed.

As described above, the ignition coils 2 are integrally supported by the base cover 3 and the top cover 4. Furthermore, the ignition coils 2 are oriented in the axial direction of the corresponding plug hole 31 of the engine 30 and are arranged at the intervals, which correspond to the intervals of the plug holes 31 of the engine 30. Thus, the ignition coils 2 can be installed to the engine 30 at once in a single step. As a result, an installation time period required to install the ignition coils 2 is reduced in comparison to the case where the ignition coils 2 are installed one by one.

Furthermore, as described above, the securing position of each ignition coil 2 relative to the top cover 4 and the base cover 3 is slidably adjustable in the imaginary plane that is perpendicular to the axis of the ignition coil 2. Thus, even when the manufacturing error in the hole pitches of the plug holes 31 occurs, each ignition coil 2 can be easily and reliably secured to the corresponding plug hole 31.

(Second Embodiment)

A second embodiment of the present invention will be described with reference to FIG. 5. Components similar to those discussed with reference to the first embodiment will be indicated by the same numerals and will not be described for the sake of simplicity.

In the second embodiment, the way of temporarily fastening the top cover 4 and the base cover 3 by the fastening bolts is different from that of the first embodiment.

That is, a male threaded portion 15b and an underhead portion 15c of each fastening bolt 15 of the second embodiment is constructed to satisfy the following relationship:

φE<φC<φD

where φE is the outer diameter of the underhead portion 15c, φC is the inner diameter of the base cover through hole 3b, and φD is the outer diameter of the male threaded portion 15b. The axial length L1 of the underhead portion 15c is longer than the sum of the length L2 of the base cover through hole 3b and the length L3 of the top cover through hole 4b.

As mentioned above, the outer diameter φD of the male threaded portion 15b is larger than the inner diameter φC of the base cover through hole 3b, so that the upper end of the male threaded portion 15b of the fastening bolt 15 engages the lower end peripheral edge of the base cover through hole 3b to prevent detachment of the base cover 3 and the top cover 4 from the fastening bolt 15. Furthermore, the top cover 4 and the base cover 3 is slidable in the axial direction of the fastening bolt 15 (i.e., the vertical direction in FIG. 5) within a range of L1−(L2+L3). Thus, as described above, the top cover 4 and the base cover 3 are temporarily fastened together by the fastening bolts 15, and the main body 2b of each ignition coil 2 is loosely received through the corresponding receiving through hole 3b of the base cover 3. As a resukt, each ignition coil 2 can be slidably adjusted within the imaginary plane that is perpendicular to the axis of the ignition coil 2.

(Third Embodiment)

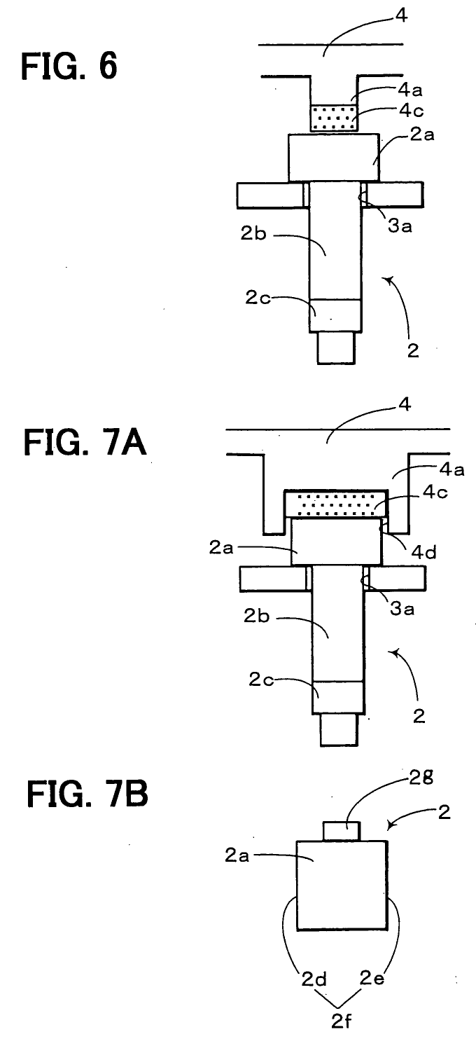

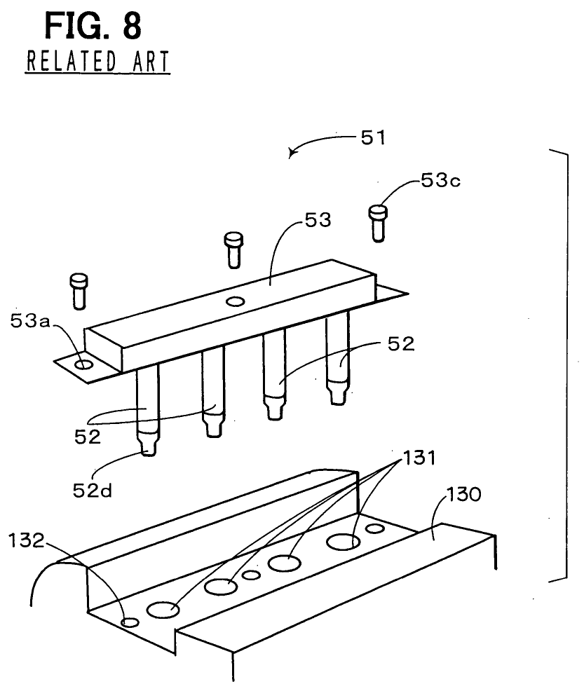

A third embodiment of the present invention will be described with reference to FIG. 6.

In the third embodiment, resilient members are provided in a lower surface of the top cover to engage with the heads of the corresponding ignition coils.

That is, in the third embodiment, a rectangular parallelepiped resilient member 4c made of a rubber material is bonded to a distal end of each coil stop protrusion 4a. Thus, the top cover 4 downwardly resiliently engages the heads 2a of the ignition coils 2 through the resilient members 4c. As a result, axial size errors, such a manufacturing error in the depth of each plug hole 31 or a manufacturing error in the length of each ignition coil 2, can be alleviated by the resilient members 4c. Therefore, each ignition coil 2 can be relatively easily and reliably installed into the corresponding plug hole 31 of the engine 30.

(Fourth Embodiment)

A fourth embodiment of the present invention will be described with reference to FIGS. 7A and 7B.

In the fourth embodiment, in addition to the resilient members of the third embodiment, there is provided a structure that prevents rotation of each ignition coil about its axis.

That is, in the present embodiment, as shown in FIG. 7A, each coil stop protrusion 4a provided in the lower surface of the top cover 4 has a recess (rotation preventing portion) 4d. A resilient member 4c made of, for example, a rubber material is received in the recess 4d of each coil stop protrusion 4a. At least a top part of each head 2a of the ignition coil 2 is received in the recess 4d of the corresponding coil stop protrusion 4a. The top cover 4 is downwardly resiliently engaged with the heads 2a of the ignition coils 2 through the resilient members 4c. Axial size errors, such a manufacturing error in the depth of each plug hole 31 or a manufacturing error in the length of each ignition coil 2, can be alleviated by the resilient members 4c, and thus each ignition coil 2 can be relatively easily and reliably installed into the corresponding plug hole 31 of the engine 30. Furthermore, as shown in FIG. 7B, which is a plan view of the ignition coil 2, the head 2a of each ignition coil 2 has a generally square shape when the head 2a is seen from its top, as shown in FIG. 7B. Two opposed parallel sides 2d, 2e of the head 2a of the ignition coil 2 form a double sided portion 2f. Thus, the double sided portion 2f includes two generally flat sides 2d, 2e that are parallel to each other. The head 2a of each ignition coil 2 received in the corresponding recess 4d is reliably prevented from rotation about the axis of the ignition coil 2 when the double sided portion 2f is engaged with the inner peripheral surface of the recess 4d. With this arrangement, the connector 2g, which projects laterally from one side of the head 2a of each ignition coil 2, can be securely positioned to always orient in a predetermined direction.

It should be noted that the present invention is not limited to the above embodiments, and the above embodiments can be modified in various ways without departing from the spirit and scope of the present invention.

For example, in the above embodiments, the top cover 4 and the base cover 3 are temporarily fastened together by the bolts 5. In place of the bolts, the top cover 4 and the base cover 3 can be temporarily fastened together by any other known connecting members. For example, the top cover 4 and the base cover 3 can be temporarily fastened together by clamping respective overlapped longitudinal ends of the top cover 4 and of the base cover 3 by a corresponding plate spring member in such a manner that the top cover 4 and the base cover 3 are urged toward each other by the plate spring member.

Additional advantages and modifications will readily occur to those skilled in the art. The invention in its broader terms is therefore not limited to the specific details, representative apparatus, and illustrative examples shown and described.

What is claimed is:

1. An ignition coil assembly for an engine, wherein the engine includes a plurality of plug holes, each of which receives a corresponding one of a plurality of spark plugs, the ignition coil assembly comprising:
a plurality of ignition coils that are arranged to be electrically connected to the spark plugs, respectively, wherein each ignition coil includes a head and a main body, which extends from the head;
a base cover that includes a plurality of receiving through holes, which penetrate through the base cover and are arranged at corresponding positions that correspond to positions of the plug holes, respectively, wherein the main body of each ignition coil is received through a corresponding one of the receiving through holes such that a gap is defined between the main body of each ignition coil and an inner peripheral wall of the corresponding one of the receiving through holes, and the head of each ignition coil is supported by the base cover around a peripheral edge of the corresponding one of the receiving through holes;
a top cover that covers a top surface of the base cover and secures each ignition coil through engagement with the head of each ignition coil; and
a temporarily fastening member that temporarily fastens the top cover and the base cover in a manner that allows sliding adjustment of a securing position of each ignition coil in an imaginary plane that is perpendicular to an axis of each ignition coil.

2. An ignition coil assembly according to claim 1, wherein:
the engine further includes a screw hole;
the top cover includes a top cover through hole, which penetrates through the top cover;
the base cover includes a base cover through hole, which penetrates through the base cover and is coaxial with the top cover through hole, wherein the base cover through hole includes female threads formed in an inner peripheral surface of the base cover through hole;
the temporarily fastening member is a screw member, which has a male threaded portion at a distal end of the screw member, wherein the screw member is received in both the top cover through hole and the base cover through hole, and the male threaded portion of the screw member is threadably securely engageable with the screw hole of the engine; and
the top cover and the base cover are temporarily fastened when the male threaded portion of the screw member is threadably engaged with the female threads of the base cover through hole.

3. An ignition coil assembly according to claim 1, wherein:
the engine further includes a screw hole;
the top cover includes a top cover through hole, which penetrates through the top cover;
the base cover includes a base cover through hole, which penetrates through the base cover and is coaxial with the top cover through hole;
the temporarily fastening member is a screw member, which is received in both the top cover through hole and the base cover through hole and includes:
a head that is located at a proximal end of the screw member;
a male threaded portion that is located at a distal end of the screw member and is threadably securely engageable with the screw hole of the engine; and
an underhead portion that is located between the head and the male threaded portion and has an unthreaded smooth outer surface;
a length of the underhead portion is longer than a sum of a length of the top cover through hole and a length the base cover through hole;
an outer diameter of the underhead portion is smaller than an inner diameter of the base cover through hole; and
an outer diameter of the male threaded portion is larger than the inner diameter of the base cover through hole.

4. An ignition coil assembly according to claim 1, wherein the top cover includes at least one resilient member placed between the top cover and the heads of the plurality of ignition coils.

5. An ignition coil assembly according to claim 1, wherein the top cover includes a plurality of rotation preventing portions, each of which prevents rotation of the head of a corresponding one of the ignition coils about an axis of the corresponding one of the ignition coils.

6. An ignition coil assembly according to claim 5, wherein:
the head of each ignition coil includes at least one double-sided portion, which includes two generally flat sides that are parallel to each other; and
each rotation preventing portion of the top cover includes a recess, which receives at least part of the head of the corresponding one of the ignition coils.
